(19) United States
(12) Patent Application Publication
(10) Pub. No.: US 2022/0320964 A1
(43) Pub. Date: Oct. 6, 2022

(54) ELECTRIC MACHINE WITH A SLEEVE ON THE END SECTION OF A ROTOR

(71) Applicant: Valeo Siemens eAutomotive Germany GmbH, Erlangen (DE)

(72) Inventors: Andreas Dietz, Bad Neustadt a.d.Saale (DE); Philipp Holzheimer, Bad Neustadt a.d.Saale (DE)

(73) Assignee: Valeo Siemens eAutomotive Germany GmbH, Erlangen (DE)

(21) Appl. No.: 17/656,958

(22) Filed: Mar. 29, 2022

(30) Foreign Application Priority Data
Mar. 31, 2021 (DE) 10 2021 203 303.2

(51) Int. Cl. H02K 9/197; H02K 5/20; B60K 1/00

(52) U.S. Cl. CPC H02K 9/197; H02K 5/203; B60K 1/00; B60K 2001/006

(57) ABSTRACT

An electric machine (1), comprising: a housing (2), in which a stator (3) and a rotor (4), which is rotatable relative to the stator (3), are accommodated, a cooling device with a cooling channel (5) through which a coolant can flow and which extends from an inlet (7), through the housing (2) and through the rotor (4), to an outlet (6), and a sealing device (21) for sealing off the rotor (4) with respect to an interior space (22) of the housing, wherein an end section of the rotor (4) is surrounded by a sleeve (10), which is surrounded by a radial shaft sealing ring (11) of the sealing device (21). Additionally described are a drivetrain for a vehicle (17), a vehicle (17) of said type, and a method for operating the electric machine (1).

The invention relates to an electric machine, comprising a housing, in which a stator and a rotor, which is rotatable relative to the stator, are accommodated, a cooling device with a cooling channel through which a coolant can flow and which extends from an inlet, through the housing and through the rotor, to an outlet, and a sealing device for sealing off the rotor with respect to an interior space of the housing.

Electric machines of this type are increasingly used in electrically driven vehicles or hybrid vehicles. Here, the electric machine is used predominantly as an electric motor for driving a wheel or an axle of the vehicle. The electric motor may be configured, inter alia, as a synchronous motor or an asynchronous motor.

The electric motor is normally mechanically coupled to a gearbox for rotational speed adaptation. The electric motor is additionally generally electrically connected to an inverter which, from DC voltage that is provided from a battery, generates AC voltage, in particular multi-phase AC voltage, for the operation of the electric machine.

It is also possible for the electric machine to be operated as a generator for the recuperation of kinetic energy of a vehicle, wherein the kinetic energy is converted firstly into electrical energy and then into chemical energy of the battery.

The rotor of the electric machine normally has a rotor shaft that is enclosed by a cylindrical rotor body. Aside from a stack of laminated metal sheets, the rotor body may have, inter alia, permanent magnets or a winding with an electrical conductor.

Owing to the heat that is generated during the operation of the electric machine, said electric machine has a cooling device for dissipating the heat, which cooling device comprises a cooling channel through which a liquid coolant can flow. The cooling channel extends from an inlet, through the housing of the electric machine and onward through the rotor, to an outlet which is formed in the housing. The coolant, which is for example a water-glycol mixture, is conveyed in a circuit.

A sealing device seals off the rotor with respect to the interior space of the housing. In particular, the coolant-filled cooling channel that runs through the rotor is sealed off with respect to the interior space in order that no coolant can pass from the cooling channel into the interior space and lead to damage there, for example as a result of corrosion. The interior space may accommodate, inter alia, the stator, and may otherwise be filled with air.

The sealing device may have, inter alia, a radial shaft sealing ring, which slides on the rotor shaft and which seals off said rotor shaft with respect to the interior space in a radial direction. This prevents coolant leakage from passing from the rotor shaft into the interior space of the housing and leading to damage therein. The damage may consist in particular in corrosion of a winding of a stator that is arranged in the interior space.

Wear may however occur on the radial shaft sealing ring or on that section of the rotor shaft which is surrounded by the radial shaft sealing ring, whereby the sealing function of the radial shaft sealing ring is impaired.

Corrosion may also occur on that section of the rotor shaft which is surrounded by the radial shaft sealing ring. In this way, rust particles can pass in the interior space of the housing and likewise lead to damage therein.

Such damage can compromise the disruption-free operation of the electric machine, in particular over a long period of time.

It is the object of the invention to specify an electric machine that can be operated without disruption over a long period of time.

According to the invention, to achieve said object, it is provided in an electric machine of the type mentioned in the introduction that an end section of the rotor is surrounded by a sleeve, which is surrounded by a radial shaft sealing ring of the sealing device.

The invention is based on the recognition that the sleeve both protects that section of the rotor shaft which is surrounded by the radial shaft sealing ring and provides a suitable surface on which the radial shaft sealing ring can slide. In other words, the sleeve forms a smooth running surface for the radial shaft sealing ring, which running surface is distinguished by its surface quality and hardness. The sleeve is thus the suitable counterpart for the radial shaft sealing ring.

Wear and corrosion are thus prevented, such that the machine can be operated without disruption over a long period of time, in particular at high rotational speeds.

That end section of the rotor which is surrounded by the sleeve preferably belongs to a rotor shaft of the rotor. Furthermore, the cooling channel of the electric machine preferably runs through a rotor shaft of the rotor. It is however also conceivable for the cooling channel to run through some other part of the rotor, for example through a rotor body of the rotor.

The sealing device is preferably configured to seal off the rotor in a radial direction and an axial direction. This prevents coolant from passing into regions outside the cooling device, for example into a bearing of the rotor shaft. In particular, any technical leakage that occurs is detained by the sealing device.

The sealing in a radial direction may be implemented by means of the radial shaft sealing ring, which thus functions as a secondary seal. The sealing in an axial direction may be implemented by means of a slip ring seal, which likewise belongs to the sealing device and functions as a primary seal.

One refinement of the invention provides for the surface roughness of the sleeve to be 0.1 to 0.32 μm. This low surface roughness ensures that the sliding movement of the radial shaft sealing ring on the sleeve takes place with low friction and without abrasion, whereby a sufficient sealing action is ensured with minimal wear. The sleeve is preferably ground without any twist.

One preferred refinement of the invention provides for the sleeve to be produced from a rust-resistant steel alloy. It can be ensured in this way that no rust particles pass into the interior space of the housing.

Hardenable chromium steels, in particular rust-resistant martensitic chromium steels with the material number 1.4034 or 1.4035, are particularly suitable as material for producing the sleeve.

It is particularly advantageous if the sleeve is hardened. Wear is thus reduced, and the proper functioning of the radial shaft sealing ring continues to be ensured over a long period of time.

As an alternative or in addition to this, the sleeve may have a coating, for example a diamond coating, that imparts particularly high hardness to the sleeve and thus increases the wear resistance thereof. The coating may for example have DLC (diamond-like carbon) or an enamelling. Such coatings are distinguished by low roughness.

In the case of the electric machine according to the invention, the sleeve may be pressed or shrink-fitted onto the rotor or welded to the rotor. The pressing of the sleeve onto the rotor or the rotor shaft is preferable.

One variant of the electric machine according to the invention provides for the sleeve to project beyond the end section of the rotor in an axial direction. In this way, the sleeve may function as a holder for a ring, which is rotatable with the rotor, of the abovementioned slip ring seal (primary seal). For this purpose, the ring may be clamped in the protruding section of the sleeve 10, such that the ring is fastened to the rotor or to the rotor shaft.

The above-stated objective is furthermore achieved by means of a drivetrain for a vehicle, which drivetrain has an electric machine according to the invention. The drivetrain may additionally have a gearbox coupled to the electric machine and/or an inverter connected to the machine, by means of which inverter a multi-phase AC voltage required for the operation of the electric machine can be provided.

The object is furthermore achieved by means of a vehicle that has a drivetrain of said type. The electric machine of the drivetrain may drive a wheel or an axle of the vehicle. The vehicle is for example a road-going vehicle, a watercraft or an aircraft.

The invention furthermore relates to a method for operating an electric machine, having a housing, in which a stator and a rotor, which is rotatable relative to the stator, are accommodated, having a cooling device, having a cooling channel through which a coolant can flow and which extends from an inlet, through the housing and through the rotor, to an outlet, and having a sealing device for sealing off the rotor with respect to an interior space of the housing.

The method according to the invention is distinguished by the fact that, as the rotor rotates relative to the stator, a radial shaft sealing ring of the sealing device slides on a sleeve that surrounds an end section of the rotor, wherein the radial shaft sealing ring surrounds the sleeve.

The advantages and details discussed in conjunction with the description of the electric machine self-evidently also apply analogously to the method according to the invention.

The invention will be discussed below on the basis of an exemplary embodiment with reference to the figures. The figures are schematic illustrations in which:

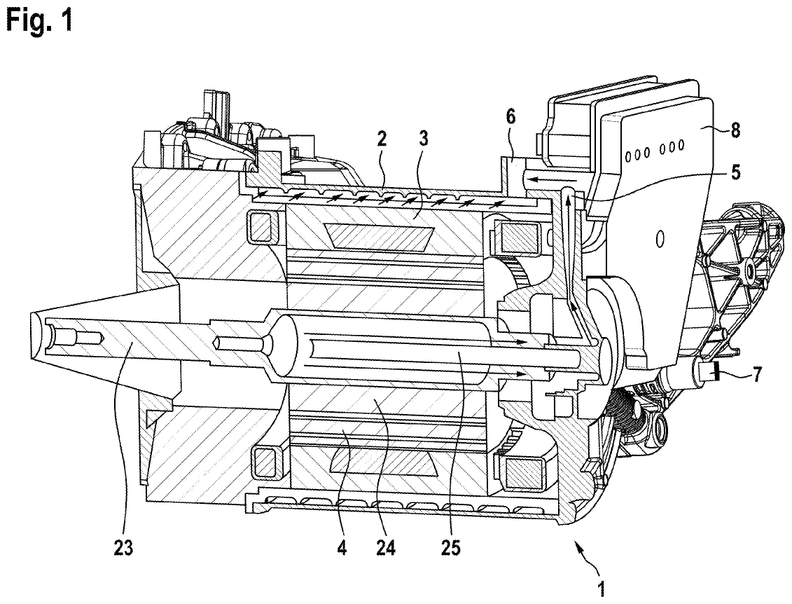

FIG. 1 shows a perspective sectional view of an electric machine according to the invention;

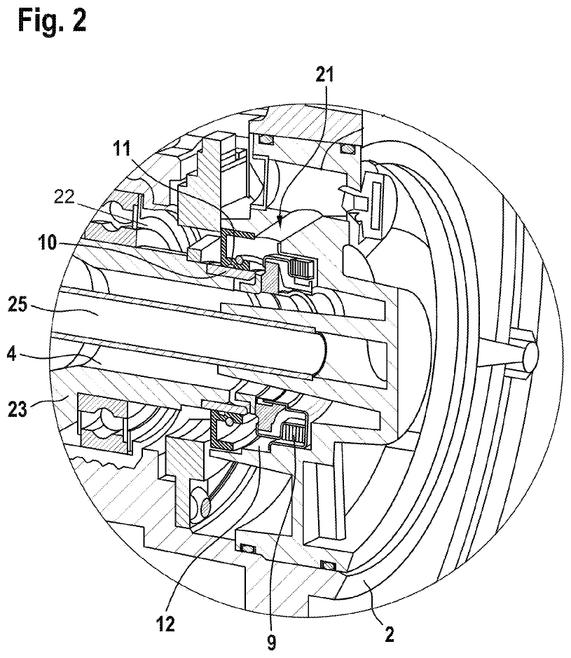

FIG. 2 shows an enlarged view of the right-hand end of the rotor in FIG. 1;

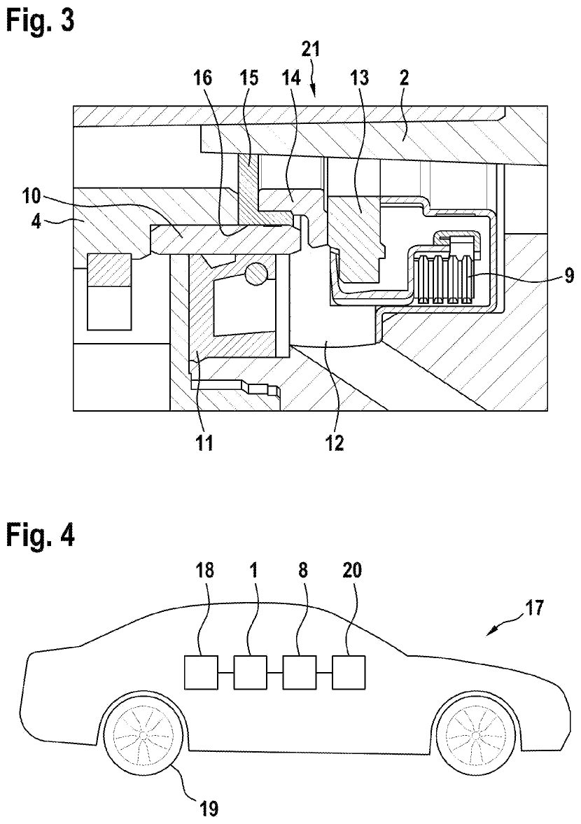

FIG. 3 shows a detail of the sealing device; and

FIG. 4 shows a vehicle according to the invention.

The electric machine 1 shown in a perspective sectional view in FIG. 1 belongs to the drive of a vehicle. The electric machine 1 may alternatively also have some other function.

The electric machine 1 comprises a housing 2 with an interior space 22 (see FIG. 2), in which a stator 3 and a rotatable rotor 4, which has a rotor shaft 23, are accommodated. The rotor shaft 23 is enclosed by a cylindrical rotor body 24. The electric machine 1 furthermore comprises a cooling device with a cooling channel 5 through which a coolant can flow and which extends from an inlet 7, through the housing 2, to an outlet 6.

The inlet 7 and the outlet 6, which may also be interchanged with one another, are connected via coolant lines (not illustrated) to a pump, such that the coolant is conveyed in a circuit. The coolant dissipates heat that is generated during the operation of the electric machine 1.

It can be seen in FIG. 1 that the cooling channel 5 extends through the housing 2 proceeding from the inlet 7. The coolant flows through a cooling pipe 25 (also referred to as a “lance”) into the hollow rotor shaft 23 of the rotor 4. At the end of the cooling pipe 25, the flow direction of the coolant is reversed, following which the coolant flows out of the rotor shaft 23 along an inner wall of the rotor shaft 23 past a sealing device 21 (see FIG. 2) and passes onward to the outlet 6. As an alternative to this, the coolant may also flow out of the rotor shaft 23 at the opposite end thereof.

On the outside of the housing 2, there is arranged an inverter 8 that provides the multi-phase AC voltage required for the operation of the electric machine 1.

FIG. 2 is a sectional view and shows the right-hand end of the rotor 4 or of the rotor shaft 23 from FIG. 1. This may in particular be the end averted from a gearbox. FIG. 3 shows a detail of the sealing device 21, which serves for sealing off the rotor shaft 23 in a radial direction and an axial direction with respect to the interior space 22 of the housing 2 and in which the stator 3 is accommodated. The sealing prevents coolant from passing into the interior space 22 and leading, for example, to corrosion of the windings of the stator 3 therein.

The sealing device 21 comprises a slip ring seal 9 and a radial shaft sealing ring 11. The slip ring seal 9 is arranged in an axial direction between the free end (on the right in FIG. 2) of the rotor shaft 23 and a section of the housing 2. The slip ring seal 9 seals off the rotor shaft 23 axially and functions as a primary seal.

The end section of the rotor shaft 23 is enclosed by a sleeve 10, which is in turn enclosed by a radial shaft sealing ring 11 of the sealing device 21. The radial shaft sealing ring 11 seals off the rotor shaft 23 radially with respect to the interior space 22 of the housing 2 and functions as a secondary seal. In particular, the radial shaft sealing ring forms a barrier for coolant leakage which has escaped from the cooling circuit at the slip ring seal 9 and which has collected between the radial shaft sealing ring 11 and the housing 2.

The sleeve 10 has particular properties with regard to roughness and hardness in order to ensure the function of the radial shaft sealing ring 11. The sleeve 10 accordingly has a particularly low surface roughness of 0.2 μm.

Furthermore, the sleeve 10 is produced from a rust-resistant steel alloy, which in this case is martensitic chromium steel with the material number 1.4034. Through the selection of this material, the sleeve is protected against corrosion. The sleeve is furthermore hardened and ground without any twist.

It can therefore be assumed that the high surface quality of the sleeve will be maintained over a long service life. The use of a sleeve that is protected against corrosion prevents rust particles from passing into the cooling circuit or into a bearing of the rotor.

The sleeve 10 is furthermore pressed onto the rotor 4. It can furthermore be seen in FIG. 2 that the sleeve 10 projects beyond the end section of the rotor 4 in an axial direction.

An encircling free space is formed between the slip ring seal 9, the radial shaft sealing ring 11 and that section in the interior of the housing 2 which surrounds the seals. A region of the free space that is situated at the bottom in the installed state of the electric machine serves as a reservoir 12 for coolant leakage, which is also referred to as technical leakage and can occur in certain operating states of the electric machine. The technical leakage collects in the reservoir 12.

The slip ring seal 9 comprises a static seal 13 and, as the counterpart thereto, a ring 14 which is rotatable with the rotor 4 and which is composed of a ceramic material. The rotatable ring 14 is fixedly connected to the rotor shaft 23. For this purpose, the rotatable ring 14 is clamped in the protruding section of the sleeve 10, in particular in an intermediate ring 15 which is arranged between the sleeve 10 and the rotatable ring 14 and which is composed of a rubber material, though said intermediate ring may also be omitted. That is to say, the sleeve 10 encloses the intermediate ring 15 along an axially extending contact surface 16, and the intermediate ring 15 encloses the rotatable ring 14, such that the rotatable ring 14 is fastened to the rotor shaft 23.

As the rotor 4 rotates relative to the stator 3, the radial shaft sealing ring 11, which surrounds the sleeve 10, of the sealing device 21 slides on the sleeve 10, which surrounds an end section of the rotor 4.

FIG. 4 shows a vehicle 17 with a drivetrain that comprises the electric machine 1 and a gearbox 18. The electric machine 1 is coupled via the gearbox 18 to a wheel 19 of the vehicle 17. The electric machine 1 is additionally connected to the inverter 8. The DC voltage provided by a battery 20 is converted by means of the inverter 8 into a multi-phase AC voltage for the operation of the electric machine 1.

### LIST OF REFERENCE DESIGNATIONS

1 Electric machine
2 Housing
3 Stator
4 Rotor
5 Cooling channel
7 Inlet
6 Outlet
8 Inverter
9 Slip ring seal
10 Sleeve
11 Radial shaft sealing ring
12 Reservoir
13 Static ring
14 Rotatable ring
15 Intermediate ring
16 Contact surface
17 Vehicle
18 Gearbox
19 Wheel
20 Battery
21 Sealing device
22 Interior space
23 Rotor shaft
24 Rotor body
25 Cooling pipe

1. An electric machine, comprising:
a housing, in which a stator and a rotor, which is rotatable relative to the stator, are accommodated;
a cooling device with a cooling channel through which a coolant can flow and which extends from an inlet, through the housing and through the rotor, to an outlet; and
a sealing device for sealing off the rotor with respect to an interior space (22) of the housing,
wherein an end section of the rotor is surrounded by a sleeve, which is surrounded by a radial shaft sealing ring of the sealing device.

2. The electric machine according to claim 1, wherein the sealing device is configured to seal off the rotor in a radial direction and an axial direction.

3. The electric machine according to claim 1, wherein the surface roughness of the sleeve is 0.1 to 0.32 μm.

4. The electric machine according to claim 1, wherein the sleeve is produced from a rust-resistant steel alloy.

5. The electric machine according to claim 4, wherein the sleeve is produced from rust-resistant martensitic chromium steel with the material number 1.4034 or 1.4035.

6. The electric machine according to claim 4, wherein the sleeve is hardened or has a wear-resistant coating.

7. The electric machine according to claim 1, wherein the sleeve is pressed or shrink-fitted onto the rotor or is welded to the rotor.

8. The electric machine according to claim 1, wherein the sleeve projects beyond the end section of the rotor in an axial direction.

9. The drivetrain for a vehicle, which has an electric machine according to claim 1.

10. A vehicle having a drivetrain according to claim 9.

11. A method for operating an electric machine, having a housing, in which a stator and a rotor, which is rotatable relative to the stator, are accommodated, having a cooling device with a cooling channel through which a coolant flows and which extends from an inlet, through the housing and through the rotor, to an outlet, and having a sealing device for sealing off the rotor with respect to an interior space of the housing, the method comprising:
as the rotor rotates relative to the stator, a radial shaft sealing ring, which surrounds a sleeve, of the sealing device slides on the sleeve, which surrounds an end section of the rotor.
